(19) United States
(12) Patent Application Publication
(10) Pub. No.: US 2004/0201668 A1
(43) Pub. Date: Oct. 14, 2004

(54) Method and apparatus for presence indication

(75) Inventors: Daisuke Matsubara, Santa Clara, CA (US); Kazuho Miki, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/411,941

(22) Filed: Apr. 11, 2003

(51) Int. Cl. H04N 7/14

(52) U.S. Cl. 348/14.05

(57) ABSTRACT

User presence information is incorporated with file displays to facilitate contacting users associated with the files. User groups are associated with information based on user presence information to further enhance a file display. The notion of presence is extended to files and file groups to still further enhance the file display.

### CROSS-REFERENCES TO RELATED APPLICATIONS

This application is related to commonly owned, co-pending U.S. application Ser. No. 10/159,144, titled “METHOD AND APPARATUS FOR PEER-TO-PEER FILE SHARING,” filed May 31, 2002 and to U.S. application Ser. No. 10/351,197, titled “METHOD AND APPARATUS FOR PEER-TO-PEER ACCESS,” filed Jan. 24, 2003, both of which are herein incorporated by reference.

### BACKGROUND OF THE INVENTION

The present invention relates to network systems and in particular to provisioning of presence information for users of the network.

Presently, most users on a network, whether a private network or the global Internet, exist as clients accessing servers to provide services. This relationship is referred to as a client-server configuration. A common service provided in an enterprise network is file sharing, where a file server provides access to files to various users connected to the network. This capability is expanding into the Internet with storage server systems such as SAN (storage area network) and NAS (networked attached storage).

Peer-to-peer (P2P) is a network communications model in which each party has the same capability and any party can initiate a communication session with another party on the P2P network. In some implementations, P2P communications is implemented by giving each communication node both server and client functionality. In a specific application, P2P has come to describe applications in which user can use the Internet to exchange files with each other directly or through a mediating server.

On the Internet, P2P can be viewed as a type of transient network that allows a group of users to connect with each other and access files from one another's systems. Napster and Gnutella are popular examples of this class of P2P software. To participate in a P2P network, the user must download and install a P2P networking program (P2P browser). The P2P browser allows the user to communicate with other P2P browsers in the P2P network, via a suitable P2P protocol. The user thus becomes a P2P node on the network.

In a “pure” P2P network, the constituent components comprise of only the users. File sharing is achieved by determining the nodes presently on the P2P network, and communication with each such node to identify the list of available files. Initially, a peer user must explicitly access another peer that is online. For example, a Web site can provided with IP addresses of other peer machines. When the user “connects” to another live machine (i.e., one that is executing the P2P program), that other live machine then tells the other peers that it has already established contact with about the new peer. Each of those peers then tell peers they know about, who tell other peers and so on. Alternatively, rather than “pushing” information out, the user's P2P program can “pull” in information about connected peers. Thus, the user's machine can obtain from the other machine a list of peers that it knows about. The user's machine can then query the other machines to identify still other machines on the P2P network, and so on. In this way, a peer can become aware of the other peers in the P2P network.

To facilitate file sharing, a “hybrid” P2P network can be configured. File sharing in a “hybrid” P2P network involves the user specifying which of her files from her computer (local computer) are to be shared P2P network, and uploading information about those files to a management (index) server. The information typically includes file location (e.g., IP address of the local computer, the directory in which each file is located, etc.) and indexing information which might include file name, file type, and so on. The most popular of such hybrid P2P networks was Napster, which utilized a central index server.

In current P2P systems, there are solutions to facilitate collaborative activities (file sharing, collaboration groupware, etc.) in which file information and user information such as “presence” can be displayed on a visual display device or otherwise presented to the user, to improve the user's coordination effort among peers and overall productivity. However, there is an increasing need to provide even more information about files and users than is presently available. For instance, a user who needs to contact the owner of a file would greatly appreciate being able to do so with very little effort.

In a conventional P2P system, there are limited ways to correlate file and user presence information. For example, a system called Groove provides a virtual ‘space’ in a P2P environment where peer members can share their files by placing them inside the space. The system allow users who can join in that space to communicate with each other and thus collaborate in real time fashion. However, the file space is simply a collection of files which does not conveniently lend itself to identify and assisting users to contact the owners of the files. Establishing contact requires the extra step of finding the owner from a list, determining her presence (e.g., is she online and available for communication?) and then attempting to make contact. This task would be unmanageable when one considers that large numbers of users can be participating in a project and can join or leave the shared space at any time. Also, when a large number of users is involved in P2P communication, it can be quite difficult to locate who is available for communication for a certain objective.

It would be useful if users can readily access owners of files in a dynamically shared environment such as in a P2P network. It can be appreciated then that there is a need to facilitate access to files in such a shared environment. It can also be appreciated that conventional client-server systems that have shared file access capability can also benefit from facilitated access to shared files.

### SUMMARY OF THE INVENTION

Embodiments of aspects of the invention include a method and a system for presenting file information along with information representing users associated with the files and their respective user presence information. An aspect of the invention includes presenting file presence information. Still another aspect of the invention is presenting users and user groups in a directory structure, and providing presence information of the users and the user groups.

### BRIEF DESCRIPTION OF THE DRAWINGS

The present invention can be appreciated by the description which follows in conjunction with the following figures, wherein:

FIG. 1 is a schematic illustration of a communication system exemplar embodying various aspect of the present invention;

FIG. 1A is a diagrammatic representation of a user computer system in accordance with aspects of the present invention;

FIG. 2 is an illustrative presentation of files and folders embodying certain aspects of the present invention;

FIG. 2A is an illustrative presentation of contact methods for a user;

FIG. 3 is an illustrative presentations of a display for showing user presence information;

FIG. 3A is an alternative presentation of FIG. 3;

FIG. 4 illustrates a presentation of a display for showing user presence information illustrating another aspect of the present invention;

FIG. 5 illustrates a presentation of a display for showing user presence information illustrating still another aspect of the present invention;

FIG. 6 is an illustrative presentation of a display for users and user groups;

FIG. 7 is an illustrative presentation of a display of user contact methods;

FIG. 8 is an illustrative presentation of an alternative display of user contact methods;

FIG. 9 is a schematic representation of a communication sequence for displaying presence information according to aspects of the present invention;

FIG. 10 is a schematic representation of a communication sequence for displaying presence information according to further aspects of the present invention; and

FIG. 11 is a schematic representation of a communication sequence to effect updates to changes in a user's presence.

### DESCRIPTION OF THE SPECIFIC EMBODIMENTS

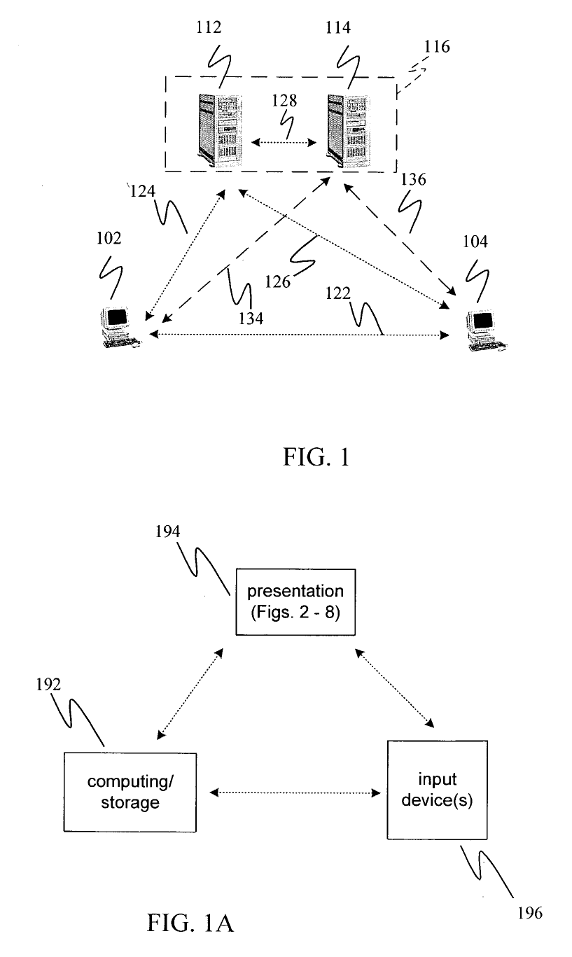

FIG. 1 is a high level generalized block diagram showing an illustrative embodiment of a networked communication system incorporating various aspects of the present invention. A plurality of user systems 102, 104 can be connected to (or otherwise in data communication with) a communication network. Though not shown, it is understood that a communication network infrastructure exists to provide data communication among various computer systems connected to the communication network. Such networks can include local area networks (LAN), wide area networks (WAN), the Internet, and private networks, virtual private networks (VPN) implemented on top of a physical network, and so on. In a particular embodiment of the present invention, a peer-to-peer (P2P) network architecture is provided.

User systems 102, 104, typically comprise a computing device running a suite a software applications to perform various tasks. One such task is to provide suitable user interfaces to allow a user to do work. The user system includes suitable user software to access other components of the invention. Particular illustrative embodiments of user interfaces (UI's) according to aspects of the invention will be discussed below. These may be provided via custom UI's, typically graphical UI's (GUI's). A user system can be a personal computer, including traditional “desktop” formats, or laptop formats. A user system can be a handheld device, such as a Palm® handheld unit, or the like. Referring for a moment to FIG. 1A, a diagrammatic representation of a user system is shown. A computing component 192 represents the computer processing hardware suitable for the particular form of the user system. Typically, computing component includes some form of CPU and related supporting logic and hardware, including memory and/or some form of high capacity nonvolatile storage.

A display component 194 provides means for presenting information to the user. Typically, this is some form of video display based on a display technology suitable for the particular form of the user system; e.g., liquid crystal displays (LCD), thin film transistor (TFT) displays, traditional cathode ray tube (CRT) displays, virtual displays, and so on. Depending on the environment, the “display” can be an audio presentation, of a combination of video and audio. One can therefore appreciate that the display component can be any suitable means for presenting the information in accordance with the present invention.

An input component 196 can be embodied in any of a number of known input devices, including any form of keyboard for keyed entry of information, a mouse, trackball, trackpad, a graphics tablet, touch sensitive displays, voice input devices, optical input devices, and so on. Typically, the input component is operably coupled to the computing component, either by a wired connection or using any of a number of available wireless technologies. FIG. 1A shows that some input devices, such as a touch-sensitive screen, are integrated with the display component 194. It can be appreciated of course that other forms of input not mentioned herein may be more suited for a particular application.

The embodiment of FIG. 1 shows a central management server (CMS) 112, also connected to the communication network. The CMS can be one or more cooperating computer systems to provide services. It can be appreciated that appropriate hardware and software components can be provided to allow the CMS to connect to a communication network and communicate with other machines also connected to the communication network.

The CMS 112 can be configured to provide file sharing services. In one embodiment, the CMS can provide a storage facility for storing files to be shared among users. The CMS can provide various services such as access to files, access control, creation, deletion, and other file management services. The storage facility can be co-located with the server machine(s) which constitute the CMS, or can be accessed offsite via a suitable data link.

In another embodiment, the CMS 112 can be configured to provide services for managing and distributing information relating to shared files, but not necessarily to provide storage for all of the shared files. This configuration is suitable for a P2P network, where the files shared among the users in a P2P network (the peer users, members, peer members, and so on) typically reside on the user' computer systems. It is understood, of course, that the CMS can be configured to provide storage space for some peer users in a P2P network.

File information management services can be provided in either configuration of the CMS 112. Services may include managing information such file names, file aliases (i.e., alternate names for a file), file ownership information, access control information, access history information, file property information, file location, and so on. Access control information can indicate levels of access (access control levels, etc.) for a file, and is usually specified by the user who owns the file. For example, read, write, and edit access are access control levels that are commonly specified for files; usually read-only access is provided. Access control information can also include access lists or pointers to such list, to give specific users various levels of access. Access lists may be inconvenient in practice, however, it can be appreciated that such list can be provided if appropriate. Access history information can include such items such as a list of users who have copied a file, or who have modified a file, and so on. In either a P2P configuration or a non-P2P configuration, where users may be allowed to modify one another's files, it might be useful to record that information. File property information might includes things as: file type—PDF, GIF, JPEG, etc.; file size; last modification date; and so on. File location information is appropriate in a P2P network where typically, the file resides on the owner's system. The specific information comprising the location information will depend largely on the underlying communication network and on the particulars of the underlying protocols used by the P2P network. A simple file location format, for example, might be an internet-based address. It can be appreciated that other kinds of information relating to shared files may become apparent as other aspects of the invention are discussed.

The CMS 112 can also be configured to provide management services for user information. The use information may include information such as user ID, login password, email address, and so on.

The services provided by the CMS 112 for managing file information and user information include update services where a user can interact with the CMS to update the file information, for example. Thus, in a non-P2P configuration, a user system configured with suitable software can interact with the CMS (shown in FIG. 1 by a communication link 124 or 126) to upload files to the CMS for subsequent sharing, or remove files from the CMS. The user can update the access levels of files. Similarly, in a P2P configuration, a user with appropriate P2P software can interact with the CMS to effect changes in the availability of her files, by updating the file information that is stored in the CMS corresponding to that user.

FIG. 1 shows a presence server (PS) 114. The PS manages “presence information,” by providing a centralized location for determining a user's “presence information.” The presence information of an entity is an indicator that conveys to other entities the access status of that particular entity. In accordance with the present invention, presence information can be managed and provided that relates to users and to the shared files, whether in a P2P network or a non-P2P environment. Thus, the present invention introduces the notion of the “presence of a file” and the “presence of a group of files,” namely directories. Further in accordance with the present invention is the idea of “presence of groups of users.” Each user has associated with that user her own “user presence information.” Similarly, each file can have its associated “file presence information.” Each user group (or group of users) can have associated with that group “group presence information.” Likewise, a group of files (or directory) can be associated with “directory presence information.”

User presence information indicates whether communication with the user associated with the user presence information is available. For example, user presence information can include status information indicating that the user is online, offline, available, busy, away, and so on. User presence information can be customized presence information; e.g., “at work”, “at home”, “at a meeting”, and so on. Techniques are known for communicating presence information. For example, user-side software running on the user system can communicate the user's status information as the state of her system changes. Thus, when she connects to the network, the software can send an appropriate message indicating that. When her machine is idle for a period of time, the user-side software can communicate that information, and so on.

User presence information can also indicate a contact method for establishing a communication session with a user. The contact method information can be used by the software to automatically select an appropriate contact method based on the user presence and system policy. For example, in a P2P network, system policy may dictate a preference for a particular contact method. In a non-P2P configuration, the user's system may dictate a particular contact method.

Typical communication techniques include voice over IP (VOIP) and instant messaging (IM). The user presence information can also include presence information for each contact method that is provided by the system. Thus, for example a user might have IM turned on but disable VOIP. This will provide a more granular representation of user presence, to further facilitate the effort for contacting that user.

As noted above, an aspect of the present invention is the idea of file presence. File presence information can include information such as whether the file is available (e.g., “online”) for access or not (“offline”). Thus in the case of a shared file in a non-P2P configuration, where the file is stored in a shared storage facility, a first user might be editing the file or otherwise have it locked out so that others cannot access it. The presence information for the file might indicate that the file is “locked” meaning it is online but unavailable. In the case of a P2P configuration, the file presence information might include information such as “online” meaning that the owner is connected to the P2P network and that file is available for copying, or some other access. It can be appreciated that other kinds of “presence” information for files may become apparent as other aspects of the invention are discussed. Some presence information typically associated with user presence may not make sense for “file presence.” For example, contact methods may not be appropriate for “file presence.” On the other hand, associating a contact method with the idea of file presence might mean establishing contact with those users who are associated with the file, or just the owners of the file, or just those who have modified the file, and so on.

An further aspect of the invention is that user presence and file presence can be independent states. On the one hand, if a user is not connected, then the file presence information relating to her shared file might indicate “offline.” This would be the case where her shared files were physically located on her machine so that if her machine is not online, then her shared files likewise would not be online. On the other hand, in a configuration where shared files can be cached in other machines or otherwise made available from other machines, the presence of such files could be “online” even though the owner of the files is “offline.”

Each user can configure various aspects of her own presence information. For example, the user can limit the presence information that is made available to other users. The user can restrict her presence information to specific users, or groups of users. Thus, she can restrict to presence on the system so that some users may never know that she is on the system. The user can restrict portions of her presence information. Thus, suppose the user can be contacted via IM and VOIP. The user can restrict her presence information for certain users or groups of users so that they can only contact her via IM, while everyone else might be permitted to contact her either by IM or VOIP.

The mechanism which allows a user to implement this kind of control is referred to as a “presence policy.” The presence policy is sometimes referred to as a presence privacy policy or simply, a privacy policy. Policy default settings might be established by an administrator, or preset in the software. In accordance with an aspect of the invention, electronic mail (email) can be recognized as a contact method in addition to VOIP and IM, and thus can be controlled via the privacy policy. Though the privacy policy, in principle, can be applied to refuse email, in practice a user may decide to always receive email.

As will be discussed below, each user's privacy policy is taken into account when presenting information representing that user's presence in the system. From the system's point of view, a user has a “universal presence” on the system for any given moment in time, “universal” in the sense that absent any restrictions any user can tell whether that user is available for communication and by which contact methods.

However, the user's privacy policy may produce a “restricted presence” that is presented to some users. Thus, the privacy policy acts as a mask, or a filter, or a modifier on the universal presence information to produce restricted presence information. Thus, if a user in “online” and can be contacted via IM only, but her privacy policy restricts a user (say, user A) to VOIP access only, then applying her privacy policy to her corresponding “universal presence” information will produce restricted presence information that indicates to user A that she user is not available, while at the same time everyone else will be see that she is available for communication via IM. This notion is applicable in a P2P network; however, it can be appreciated that this idea can also be incorporated in a non-P2P configuration.

As can be seen in FIG. 1, user peers in a P2P network, can interact via links 124, 126 with the CMS 112 to exchange user presence information. Thus, when a peer user enters the P2P network, her presence information can be communicated to the CMS via her user system 102. Similarly, when her presence changes, that change can be communicated to the CMS. Each peer user (e.g., 102) can communicate its presence information to the CMS. In addition, user' privacy policies can be communicated to the CMS.

As will be discussed below, the CMS can communicate presence information about each peer user to other peer users. Similarly, file presence information relating to shared files on a peer user's system can be provided to the CMS, which in turn can then be communicated to the PS. As with user presence information, file presence information can be provided by the CMS to the peer users.

In the embodiment shown in FIG. 1, the CMS 112 and the P 114 are separate machines. A link 128 between the CMS and the PS can be provided, over which presence information received from each peer user by the CMS can be transmitted to the PS. The CMS and PS can be operationally separate components; i.e., each runs on a different computer system. This may be convenient where a large number of users are managed from a throughput point of view. However, it can be appreciated that on a smaller scale, the CMS and PS components can be implemented on the same computer system. This single-configuration alternative is represented in FIG. 1 by the reference numeral 116.

In an alternative configuration, a link 134 can be provided which allows peer users to directly communicate with the PS 114 to allow the peer users to upload their user presence information and file presence information. In yet another alternative configuration, some peer users can communicate with the CMS 112 to transmit their presence information, while other peer users can communication with the PS. Though the PS 114 is suited for a P2P network, it can be appreciated that a non-P2P network can include a PS component to provide certain aspects of presence information management that are appropriate for a non-P2P configuration.

FIG. 1 shows a link 122 between users 102 and 104. This link represents communication between peer users in a P2P network, allowing peer users to share files amongst each other. In another context, the link represents communication sessions (channels) amongst users, whether in a P2P network or in a non-P2P configuration, via contact methods such as VOIP, or IM.

In accordance with various aspects of the invention, user presence information and file presence information are presented to the user. In one embodiment of the invention, user-side software can be provided that includes a suitable user interface (UI). Typically, the interface will be a graphical user interface (GUI); however, it can be appreciated that other presentation formats might be more suitable, e.g., a command line interface (CLI) where users enter commands to display information. Thus, in the case of a P2P network, the user can load onto her system suitable P2P software containing a user interface component.

In another embodiment of the invention, the user interface can be a web page hosted at a web site that is accessed by a suitable browser. A web page is well suited for non-P2P users. However, a P2P network can be accessed via a web browser (e.g., Netscape, Internet Explorer, etc.), as described in co-pending U.S. application Ser. No. 10/351,197. A peer user accessing a P2P network in such a manner can exchange its own presence information with the CMS 112 or the PS 114 by way of a set of applets (e.g., Java) provided by the web site. A similar set of applets can be used to obtain from the CMS and/or the PS presence information relating to shared files and other peer users. This processing of presence information can occur in the background. Alternatively, links can be provided to the user so she can manually change her presence information.

Following is a discussion of various forms of presenting user presence information and file presence information and utilizing the information, in accordance with the invention. The representations are schematized and intended to highlight aspects of the invention.

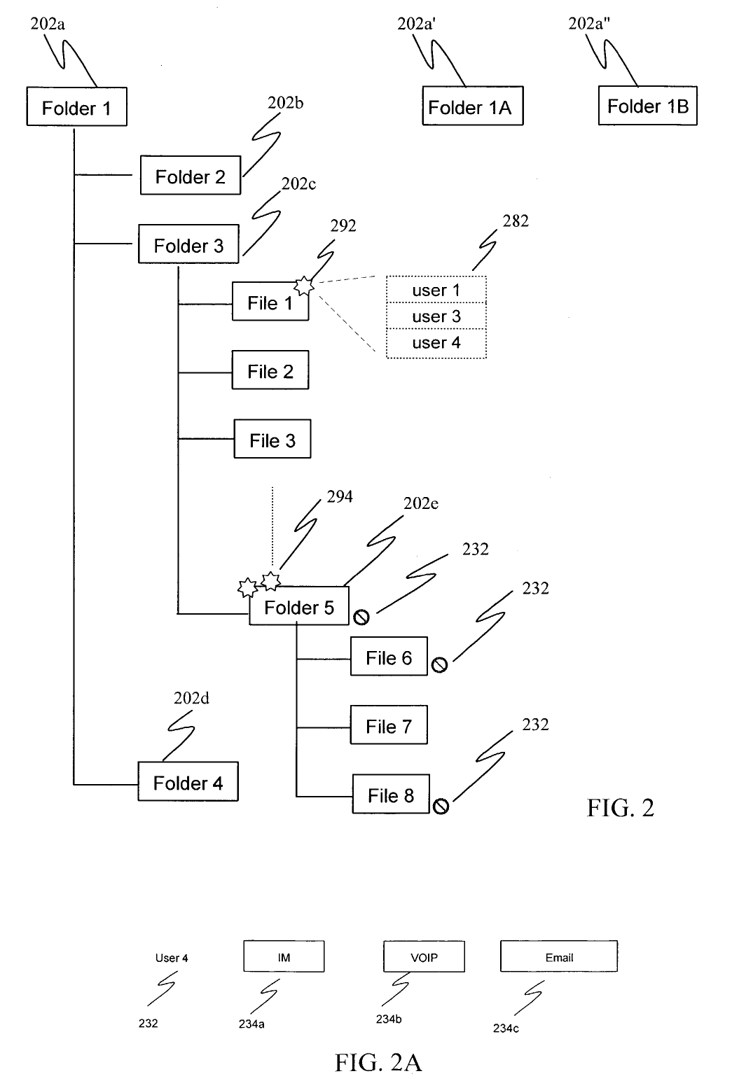

FIG. 2 shows the content of a display according to an embodiment of one aspect of the invention. The figures shows an arrangement of files presented in a hierarchical structure (directory tree). The structure can be created and maintained in the CMS 112. Files can be added and removed from the hierarchy by users, whether they are peer users in a P2P network or users in a non-P2P environment accessing the CMS as a shared file system. The hierarchy can be re-arranged in accordance with whatever policy is in place for the shared file system. Files can therefore come from any user who is permitted to access the hierarchy, and can be modified by anyone having sufficient access. In a P2P network, sub-trees in the hierarchy may represent the entire (or a portion) of the directory tree of the shared files on a peer user's system.

Directories 202a-202e can be presented as graphical representations of a folder, or textually, or as some other object. A top-level folder 202a can represent the entire set of shared files. Alternatively, the shared files can be organized into two or more “top-level” folders 202a, 202a′, 202a″, and so on, with suitable access policies for users. The contents of a directory can be presented (expanded) when the UI detects an indication from the user to display the contents; for example, the user using a mouse might “double click” on the graphic for a folder to see its contents. Thus, FIG. 2 shows “Folder 3” having been opened. Folder 3 contains files 1-3 and another folder, “Folder 5.” Files can be represented by appropriate graphical elements. Conversely, an expanded folder, when double-clicked for example, can be collapsed.

In accordance with an aspect of the invention, FIG. 2 shows that presence information can be obtained for users having some association (or relation) with a file. For example, a user can be “associated” with a file by virtue of being the owner. Another user can be deemed to have an association with the file because she edited the file. Depending on the policy, a user may be deemed to be associated with the file simply because she accessed the file. Without loss of generality, it can be assumed for the sake of discussion that a user is associated with a file if she owns it, or had modified it; keeping in mind that the criteria for who is “associated” with a file (or a directory) can be defined in any way that is suitable for a particular implementation.

The figure shows illustrative techniques for accessing presence information for an associated user. Consider “File 6” under Folder 3, for example. A user can select the file (indicated by an action indicator 292) to obtain a list of associated users. The action indicator is merely an illustrative representation of the abstract notion of selecting. For example, a common technique in the PC world is to place the mouse cursor on the graphic representation of “File 6” and right click on it, in which case the action indicator 292 represents a right-click action on a two- or three-button mouse. In an Apple Macintosh PC, the action indicator might represent a double click action. It can be appreciated that the specific action of making a selection will depend on the input device.

In response to detecting an indication of the selection, the UI can display a list 282 of the users associated with “File 6.” The user can then select a user from the list of associated users, for example, by dragging the mouse to the desired user. For example, the user might right-click, and while “holding the click”, drag the mouse to the desired user and “release the click.” Again, the specific physical actions will depend on how the list of associated user 282 is presented, and the particulars of the input device. For the discussion which follows, it will be understood that other presentation and interaction formats can be readily realized by those of ordinary skill in the relevant art, in addition to the embodiments that will be described.

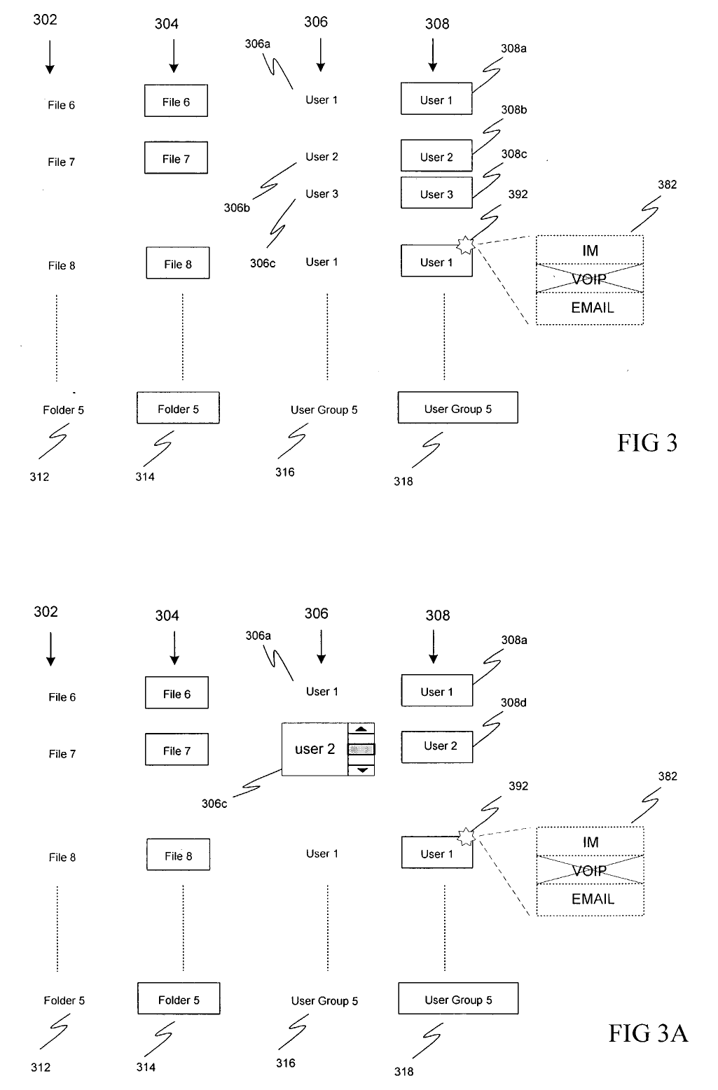

FIG. 2 shows another technique for accessing presence information. A folder can be selected, for example, by right clicking (e.g., indicated by the action indicator 294 on Folder 5) on a folder. In response, the UI can present the presence information for the users associated with each of the files in Folder 5. This is shown in FIG. 3, to be discussed shortly.

Still another technique can be based an interface provide through a web page. For example, the can click on a file (e.g., “File 6”). This action can result in loading another web page on which is displayed a list of associated users. Clicking on (selecting) one of the listed associated users can then cause yet another page load, to show the presence information of the selected user.

In the case of a directory, a web page can be loaded to display the information illustrated in FIG. 3. It is noted that frames can be used instead of, or in combination with, loading an entire page. Frames might allow for more flexible and useful presentations. It can be appreciated that these and other web page technologies can be used.

Refer for a moment to FIG. 2A. This figure illustrates an illustrative presentation of presence information for a selected user (User 4) associated with the selected file (“File 6”). First, there is identification information 232 which identifies the user. Next, are presence indicators 234a-234c which, in the case of a video-based presentation, can be graphical elements; e.g., a box icon, radio button, or the like. Each presence indicator represents a contact method by which the identified user can be contacted. For example, the presence indicator 234a represents contacting the user using IM technology. The presence indicator 234b represents contact with the user using VOIP technology.

The presence indicators 234a-234c tell a user whether the identified user can be contacted via the corresponding contact method. For example, a presence indicator can be grayed out if the user cannot be contacted by the method corresponding that indicator. Alternatively, an “X” image can be shown superimposed over the indicator. The indicator may simply not be shown if the corresponding contact method is not available. Still other indication methods, of course, are possible.

A presence indicator 234c is also provided to represent contact with the user via email. As discussed above, an aspect of the present invention is associating the idea of “presence” with email. Email can be sent to a user at any time, and thus does not require the user be present on the system for contact. However, according to the invention, the idea of a user's presence can be extended to email by projecting her desire whether and/or from whom email will be received or not. This allows other users to know immediately whether the identified user is willing to access email.

Recall that the privacy policy for a user specifies who can contact that user and by what methods. The user can disable specific contact methods for a certain user or users. The user can disable all of the contact methods for select users, and so on. Thus, the presence information for a particular user that is presented to other users can be different from user to user.

A communication session can be initiated by selecting a presentation indicator 234a-234c that has not been disabled by the identified user. Techniques are known for establishing communication using IM technology and VOIP technology.

To complete the description of FIG. 2, refer to Folder 5 and its constituent files. Presence indicators 232 can be provided for each file and folder, indicating file presence and group file presence. In the particular implementation of this aspect of the invention, an indicator is presented when it is deemed that the file or file group is “offline.” Of course, other presence information can be represented; e.g., “online, but locked,” “being edited,” and so on. Other representation means can be provided as well. The presence indicator associated with Folder 5 represents “presence” of the folder. As will be discussed below, the “presence” of a folder (group of files, directory, etc) can be based on the “presence” of its constituent files and/or folders.

In a P2P network, the presence information for a file or folder can include “online”, “offline”, and so on. A file that is “online” indicates that file is available to be shared over the P2P network. Recall that a file being “online” may not be correlated with whether the owner is online, if the file is cached or otherwise accessible from machines other than its machine of origin. Suitable file presence information might include “locked” (not readable), “being edited”, and so on.

It can be appreciated that file presence might have a place in a non-P2P configuration, for example, in a shared file system architecture such as a file server. However, in such a system a file that has a presence of “online” essentially reflects the online status of the file server, since the file is always available provided that the file server is online. Thus, in a non-P2P configuration, a file whose presence indicates “online” might take on a modified meaning. If appropriate, an “online” file in a non-P2P configuration may reflect the online status of the owner of the file. It is worth noting that other file presence status information such as “being edited” would be appropriate, while other status information might not be appropriate.

FIG. 3 shows an illustrative presentation of presence information that might be given when a folder is selected as described, for example, in the manner shown in FIG. 2. In accordance with an aspect of the invention, the shared files are presented along with users associated with the files. More significantly, an aspect of the present invention is the display of only those users who have an association with the listed files. As mentioned above, a user can be associated with a file by virtue of being an owner of the file, one who has edited the file, and so on.

Thus, the presentation example of FIG. 3 shows a list of the files 302 and only those users associated with the listed files. Although not shown, folders (sub-folders, sub-directories, etc.) contained in a selected folder nevertheless can also be shown. Each file or folder can be represented by a suitable graphic with identifying information (e.g., text). An aspect of the invention is illustrated as an online status indication field 304 associated with each file, showing the online status of each file. This aspect of the invention will be discussed in more detail. A list of identifiers 306 of the users associated with each file can be provided. As shown in the alternate format of FIG. 3A, a scrollable window might be presented where there are “many” associated users, allowing a user to scroll through a long list of users associated with a particular file.

A presence indication field 308 can provide presence information for users associated with a file. FIG. 3 shows that “User 1” is associated with “File 6” and so, according to a particular embodiment of the invention, a presence indicator 308a is provided which allows a user to access the presence information of the user associated with a file. Thus, in one embodiment, a user can perform a right-click action (indicated by an action indicator 392) on the presence indicator to display a list 382 of contact methods for the user. The display shown in the figure indicates that VOIP is not available, as indicated by the overlaid “X”.

If more than one user is associated with a file, each user can be presented. For example, FIG. 3 shows that “File 7” is associated with two users; e.g., “User 2” might be the owner of the file and “User 3” might be someone who modified the file. A line entry is provided for each user, including and identifier 306b, 306c and a presence indicator 308b, 308c.

As can be seen in the alternate display shown in FIG. 3A, where there are many users associated with a file, a scrollable window 306d can be provided in place of the individual identifiers 306b, 306c of FIG. 3. The scrollable window allows a user to scroll through the list of user identifiers. Accordingly, a single presence indicator 308d can be provided in place of the individual indicators 308b, 308c. The single indicator can provide presence information that is determined from the presence of the user who selected in the scrollable window 306c, “User 2” in FIG. 3A.

To complete the description of FIG. 3, the bottom of the presentation exemplar shows folder information that can be displayed relating to the folder which contents are being displayed. This can include information corresponding to the information that is presented for the folder contents, including an identifier 312, an online status indication 314, a “user group” indication 316, and a user group presence indication 318. The fields will be discussed below in more detail.

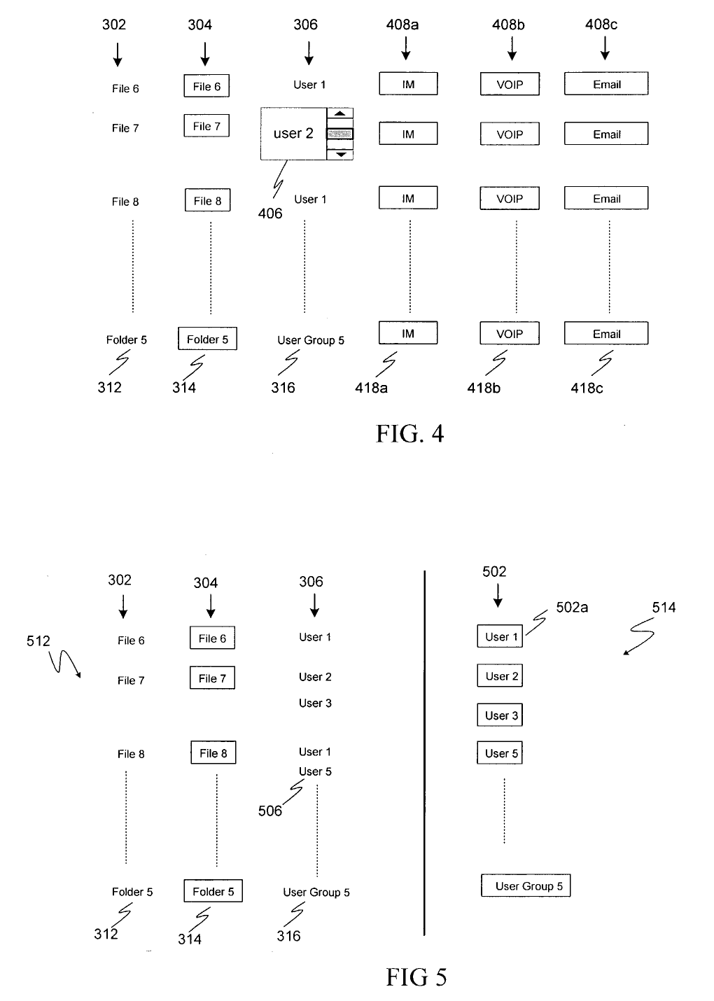

FIG. 4 shows an alternative presentation which incorporates the display format of FIG. 2A. As an alternative to the presence indicators 308 shown in FIG. 3, the various contact methods for each user can be presented. For example, the indicators 234a-234c shown in FIG. 2A can replace each of the indicators 308. Thus in FIG. 4, fields 408a-408c are contact method indicators for each user. Each contact method, if it is enabled, can be activated by an appropriate selection action; e.g., double-clicking. FIG. 4 also shows individual contact methods 418a-418c for the “user group.” FIG. 4 illustrates an example of a scrollable window 406 (mentioned above) as an alternate means for listing multiple users associated with “File 7.” It is worth noting again that, in accordance with an aspect of the invention, the users who are displayed are only those users who are associated with the displayed files. As the list of displayed files changes, so will the displayed users.

FIG. 5 shows yet another alternative presentation which embodies aspects of the invention. The figure shows two presentation areas 512, 514. In the illustration shown in the figure, a solid vertical line divides the two presentation areas. The presentation area 512 shows the contents of the folder “Folder 5” as in FIGS. 3 and 4. File identifiers 302 can be some graphical or textual representation which identifies each file. File presence indicators 304 are presented for each file.

In accordance with an aspect of the invention, only those users 306 who are associated with each file are presented. Whereas, the presence indicators in FIGS. 3 and 4 were provided for each user associated with each file, duplication of presence information can occur if the same user (e.g., User 1) is associated with more than one file. This can be inconvenient in that the duplicated presence information may consume valuable display area in a video display device. FIG. 5 shows a second presentation area 514 in which presence indicators 502 are presented once for each user appearing in the first presentation area 512. Thus, while “User 1” may appear twice in the first presentation area 512, a single presence indicator 502a is presented only once in the second presentation area 514.

FIG. 5 illustrates another aspect of this particular embodiment of the invention, namely, a user who cannot be contacted can be represented in the second presentation area 514 as being “offline”. For example, if the user logs out of the system, then that user cannot be contacted. Another situation is if the user's system detects a long period of non-activity (idle) it may mean she is not at her system and thus may be deemed to be incommunicado. In that case the presence information may indicate “not at desk” or something similar.

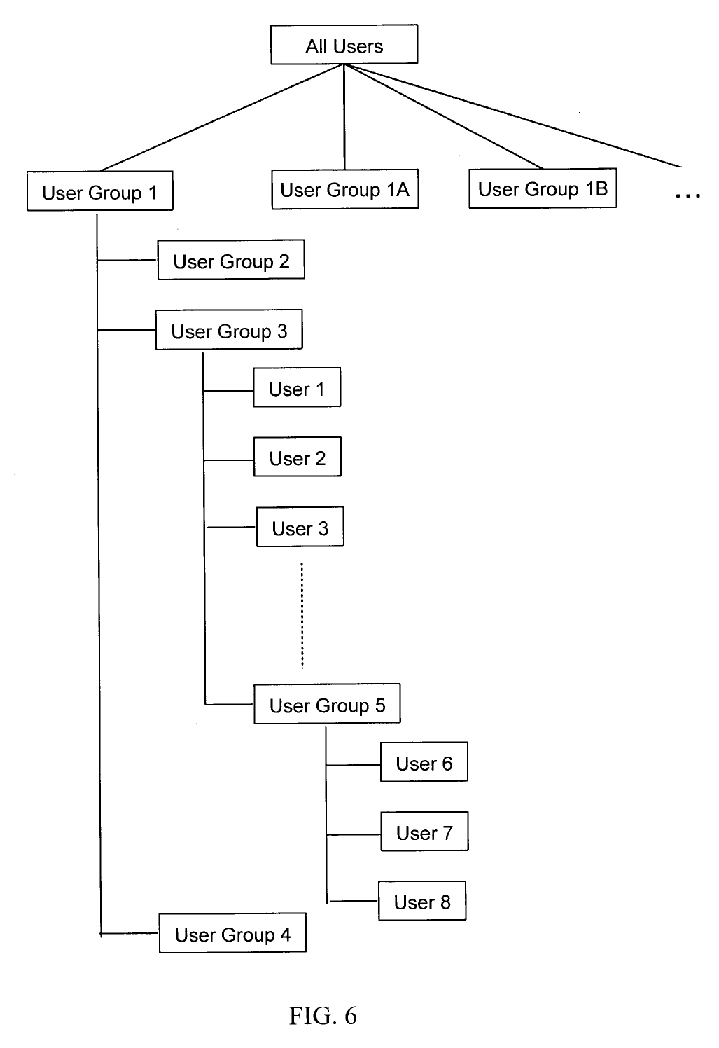

FIG. 6 is an illustrative presentation of another aspect of the invention in which user groups can be represented and presence information can be accessed. The figure shows a hierarchical arrangement of all users in various groups. Thus, the users in “User Group 1” are shown organized into sub user groups. As with the file hierarchy of FIG. 2, user input actions (e.g., clicking with a mouse) can expand or collapse portions of the display of the hierarchy. For example, double-clicking on “User Group 5” can “close” that user group, much like folders might behave in a windows-based desktop UI. In accordance with this aspect of the invention, presence information for the users in the group can be obtained, for example by double-clicking the user group.

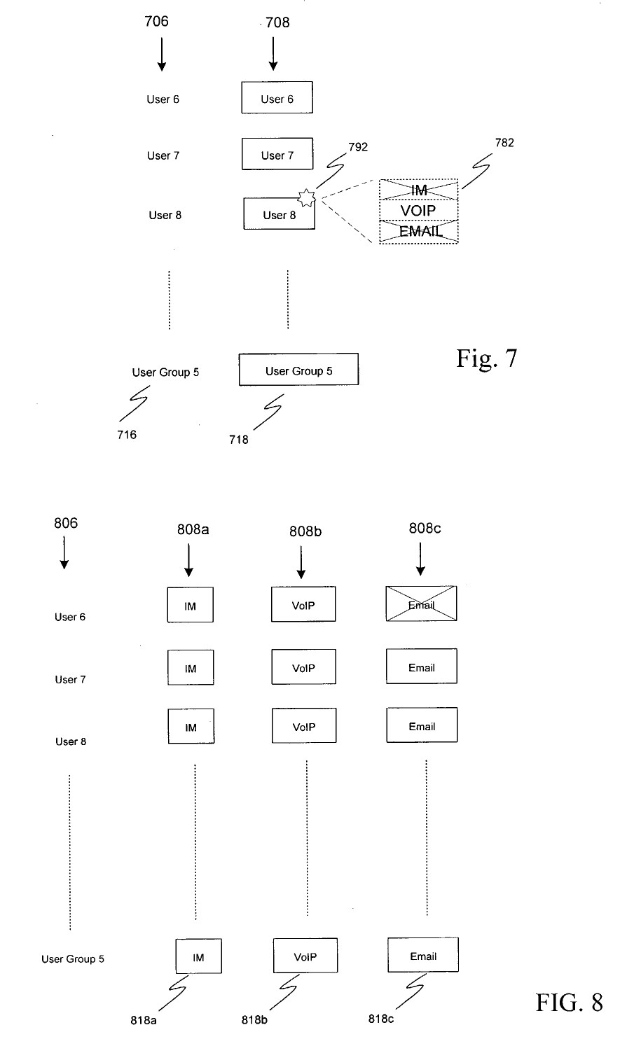

FIG. 7 shows an illustrative presentation of presence information that might result when a user clicks on “User Group 5” shown in FIG. 6. As can be seen in FIG. 7, each user in User Group 5 is listed. Information 706 representative of each user can be provided, including identification information 716 to identify the user group. Presence indicators 708 are presented for each user providing access to their presence information. A presence indicator 718 is provided for the group as well. In one implementation, the presence indicator for a user who cannot be contacted might be dimmed, grayed out, X'd out, or otherwise indicate that the user cannot be contacted. Alternatively, a presence indicator can be omitted for a user to whom communication is not possible.

In the particular embodiment of this aspect of the invention shown in FIG. 7, access to the user's presence information can be obtained by right-clicking (action indicator 792) on a user's presence indicator. As can be seen in the figure, a pop-up list 782 can be displayed, showing the available contact methods. Here, “user 8” has enabled voice over IP as the only contact method.

FIG. 8 illustrates an alternative representation in which the presence information shown as contact methods 808a - 808c for each user is presented. Thus, for example, to contact “user 7”, contact with that user can be made by any contact method. However, “user 6” has disabled the email contact method 808c. Recall, that the presence privacy policy for each user can enable or disable one or more contact methods for one or more users. Thus, the presentation shown in FIG. 8 indicates that “user 6” has disabled email contact. This could apply to the user whose display is shown in FIG. 8, or to everyone.

As mentioned above in the various figures an aspect of the invention is the presentation of presence information for groups of users. For instance in FIG. 7, the “User Group 5” graphic is an indicator 718 of presence information related to “User Group 5.” Presence information for a user group is compiled based on the “presence” of each group member (users that are placed under that group folder) and on one or more optional pre-set policies for deciding the “presence” of a user group. For example, one policy may be deem a user group to be “online” (e.g., available for communication) when at least one member of the user group is online at that time. Another policy may be to indicate in some appropriate manner the number of online and/or offline users for that user group. Still another approach may be to determine the “presence” of the user group based on how many (e.g., percentage) users in the group are “online.”

In accordance with this aspect of the invention, contacting a user group can be embodied as contacting each member of the user group. FIG. 8 shows the presence information of user group can be shown for each contact method 818a-818c. In FIG. 3, “User Group 5” is shown with a presence indicator 318 and access to the contact methods can be obtained by right-clicking on the indicator, or by double-clicking, or by some other selection indication action appropriate for the presentation (e.g., voice activation). In one embodiment, a selected contact method can result in an attempt to establish contact using that method (e.g., IM) with those members of the user group who have enabled communication via the selected contact method.

Also mentioned above is another aspect of the invention wherein the online status of a folder can be shown to represent the online status for groups of files; for example files shared in a P2P system, or shared files in a file server in a non-P2P configuration. In FIG. 3, the online status of Folder 5 is shown in the list. The online status of a folder can be compiled based on online status of each file under the folder and pre-set system policy, in a manner similar for user groups. For example, under one policy the “presence” of a folder may be deemed to be “online” when at least one file under the folder is online at a certain time. Another policy may be to show the folder as being “online” when more that a certain percentage of the files under the folder is online. Still another policy may be to show percentage of online files. This can also be applied for presence indicators 314 of the folder shown in FIGS. 4 and 5.

Furthermore in FIGS. 3, 4, and 5, the user and user group presence can be presented differently depending on the file/folder's online status. For instance, if the file or folder is offline, user or user group presence might not be shown. As another example, if the file or folder is offline, the user or user group presence can be replaced by a notification message such as “no online files found.”

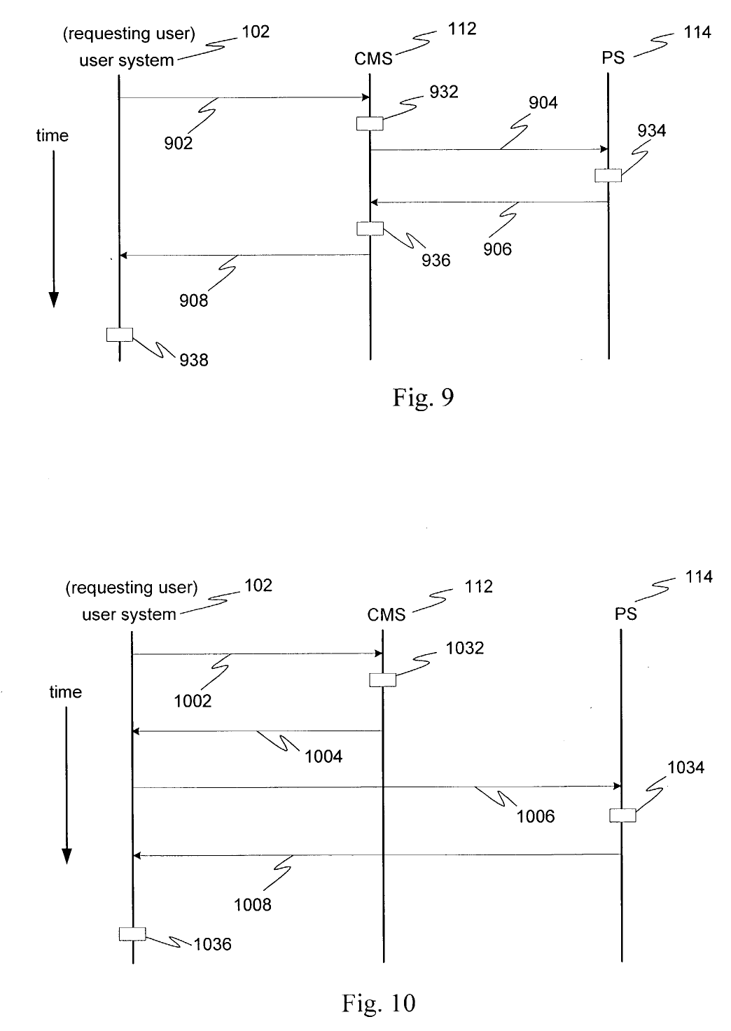

FIG. 9 shows a communication sequence according to an aspect of the invention wherein a user system can obtain file/folder and presence information from the CMS 112 (FIG. 1) and the PS 114. As shown in the figure, time advances in the downward direction. At some point in time, the user system will communicate 902 with the CMS to request file/folder information. The request might be for an entire directory (folder) with its subdirectories, or for a particular folder and its contents, or for a particular file. For the sake of discussion, an example for obtaining the contents of folder will be given. The communication 902 is represented abstractly by a single arrow. However, depending on the implementation, there may be a series of exchanges to convey the request for file information.

Thus, having received the request for information pertaining to a folder (e.g., “Folder 3”) and its contents, the CMS 112 performs necessary processing 932 to retrieve the requested information. For example, the CMS might look into its database to retrieve information regarding files and folders registered under Folder 3. This includes determining the associated users and user groups for each file. The CMS maintains group information in addition to user information. The CMS manages the creation and modification of user groups, allowing for the addition and deletion of group members. The CMS then communicates 904 a request to the PS 114 to obtain presence information for each user identified by the CMS including communicating information identifying the user of the requesting user system making the request, again recognizing the possibility that the communication 904 may comprise a series of exchanges of information between the CMS and PS. This may include sending the list of associated users to the PS.

Having received the request for presence information, the PS 114 performs necessary processing 934. This may include retrieving the presence privacy policy for each associated user and determining the “universal” presence information of that user. The universal presence information is then “masked” or filtered according to the privacy policy to produce “restricted” presence information. This will involve taking into consideration the requesting user, and applying any restrictions called out in the privacy policy for the requesting user. This masking process is performed to determine restricted presence information for each associated user. In some cases, where there an associated user has no restrictions, the “restricted” presence information will be the same as the “universal” presence information, and the requesting user will see that associated user's universal presence. The restricted presence information is then communicated 906 to the CMS.

The CMS 112 processes 936 the restricted presence information in a process referred to herein as “compiling,” in which presence information is determined for any user groups that might be defined for the users that are associated with the files under “Folder 3.” Thus, based on predetermined policies (group presence policy), the presence of a user group can be determined from the presence of the users in that group. An example might be to count the number of members in a user group who are online. If that number is fifty percent or more, then the user group is deemed to be online. Alternatively, the contact methods enabled by each user may be taken into consideration, and so on.

A similar compiling process can be applied to determine the “presence” of a group of files (e.g., directory of files). The presence of a file group can be established based a percentage of files in the group that are “online.” Alternatively, a threshold can be used wherein if the number of files that are “online” exceeds the threshold, the presence of the group of files is deemed to be “online.” File group presence can be determined in a recursive manner by taking into account the presence of the sub-directories in the file group, in addition to the files. As an example, refer to FIG. 2. Here, the presence indicators 232 represent an “offline” presence status. Folder 5 is deemed to be “offline” because more than one-half of its constituent files are “offline.”

The file/folder information, the user presence information, and the compiled presence information can then be communicated 908 to the user system. The user system can then process the received information 938 and assemble the information into a suitable presentation. Various embodiments include visual displays, virtual displays, audio presentations, and so on.

In the sequence of FIG. 9, the CMS 112 performs the function of applying the policy for compiling user presence information to determine user group presence. FIG. 10 illustrates an alternate embodiment of this aspect of the invention. As will be explained in the sequence shown in FIG. 10, the compilation can be performed in the PS 114. As in FIG. 9, each communication shown may represent a sequence of communications to convey the discussed information. For example, sending a request for file information may involve a series of communications between the user system and the CMS.

The user system communicates 1002 a request for file/folder information to the CMS 112. Again, consider an example where contents for “Folder 3” is requested. The CMS 112 performs necessary processing 1032 to retrieve the requested information. For example, the CMS might look into its database to retrieve information regarding files and folders registered under Folder 3. This includes determining the associated users and user groups for each file. The CMS then communicates 1004 to the user system the file/folder information, the restricted presence information corresponding to users associated with the files, and the user groups.

The user system then communicates 1006 the received information to the PS 114. Having received the list of users and user groups, the PS 114 performs necessary processing 1034 to produce compiled presence information. This may include retrieving the presence privacy policy for each associated user and determining the “universal presence” of each such user. The presence is then “masked” or filtered according to the privacy policy of that user to produce restricted presence information as discussed above. This masking process is performed to determine the presence information for each associated user, as it will be presented to the requesting user. The universal presence information for each associated user, suitably filtered according to the privacy policies to produce restricted presence information, is then compiled to determine presence information for each user group according to predetermined group presence policies.

The compiled information is then communicated 1008 to the user system. The user system then processes 1036 the file/folder information, the restricted presence information, and the compiled information and generates a suitable presentation of the information.

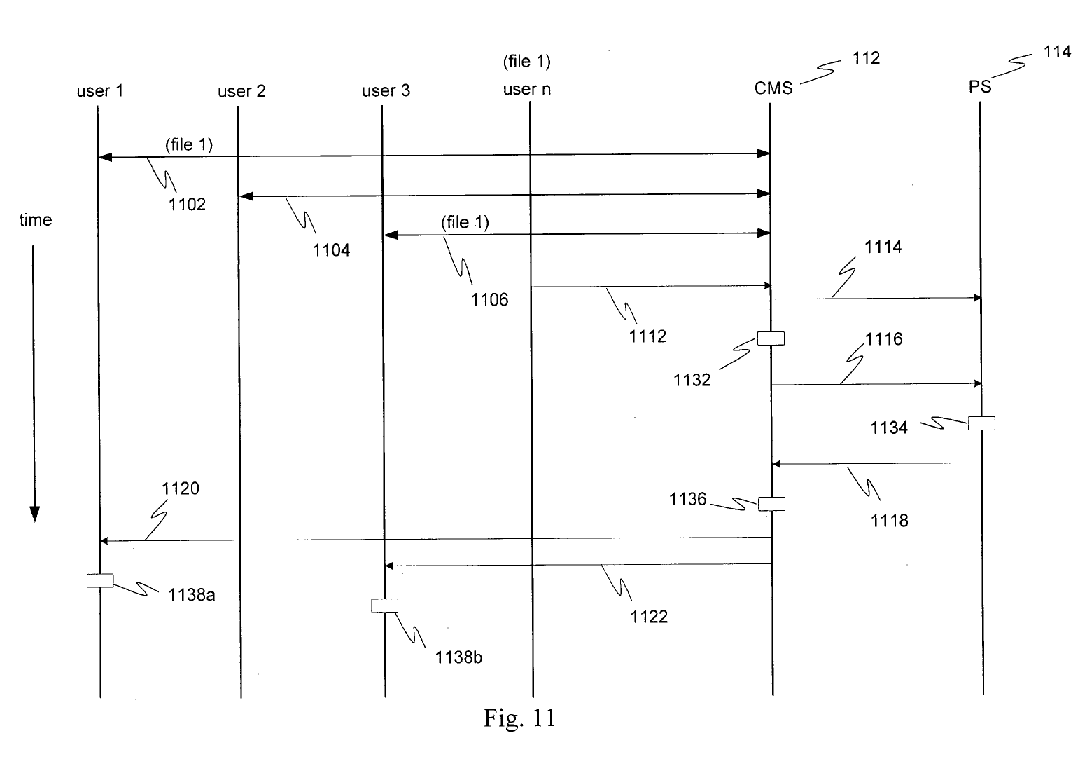

FIG. 11 is an example illustrating yet another aspect of the invention wherein when the “presence” of a user changes, the presence information for that user can be “pushed” or otherwise communicated to other users. For example, when User N has been idle for a period of time, the user system of User N can detect that and initiate a change of the state of User N's presence, say from “online” to “idle,” indicating perhaps that User N may not be available for a communication session. Other users on the system can be notified of User N's change of “presence” and their respective systems can present the change in a manner appropriate for the particular system; e.g., update a video display.

The example of FIG. 11 indicates that User 1 has requested file/folder and corresponding presence information for one or more files, including File 1, in a manner such as shown in FIG. 9 or FIG. 10 for example. The communication 1102 represents the communication sequences needed to obtain the information. Similarly, User 2 is indicated as having made a request 1104 for information for one or more files and corresponding presence information. Notably, User 2's file request does not include File 1. User 3 also is shown having made a request 1106 for file/folder information and the corresponding presence information. User 3's request includes File 1. It can be appreciated of course that the request of User 1 can be for a set of files different from that of User 3, even though File 1 may be common between the two users. The example of FIG. 11 further indicates that File 1 is owned or otherwise associated with User N.

FIG. 11 shows that at some time subsequent to the communications 1102-1106, the presence of User N has changed. In response, User N's system communicates 1112 with the CMS 112 (FIG. 1) to report the change in User N's presence. In the particular embodiment shown in the figure, the CMS communicates 1114 the change in User N's presence to the PS 114. The change in presence information for User N is noted in the PS.

The CMS then accesses 1132 a “watcher list” associated with User N. In accordance with an aspect of the invention, a “watcher list” for each user is maintained. Additional details for the watcher list are presented below. Briefly, the watcher list for a user (User X) identifies those users who need to be notified when User X's presence changes.

Continuing, the CMS communicates 1116 the watcher list to the PS. The PS then generates 1134 restricted presence information corresponding to User N for each user in the watcher list. As discussed above, the restricted presence information is based on the User N's universal presence information and User N's privacy policy. Thus, for each user in the watcher list, restricted presence information will be determined based on the restrictions set in User N's privacy for that user. In any given situation, this may result a small number of variations of restricted presence information. The restricted information is then communicated 1118 to the CMS. In a particular implementation, the CMS can send the entire watcher list to the PS, which will then process the list produce a complete list of restricted presence information. Alternatively, the CMS and PS can iteratively, perform the sequence for each user in the watcher list. Still other implementations, of course, can be realized.

Next, the CMS determines 1136 which users should be updated to reflect the change in User N's presence. This determination can be based on the watcher list. Thus, for each user that should be updated, the CMS communicates 1120, 1122 to the users, the appropriate restricted presence information for User N; i.e., the restricted presence information that was intended for that user. Thus, User 1 and User 3 will be updated because they had earlier obtained information for File 1. Restricted presence information prepared for User 1 will be delivered to User 1's system to be displayed 1138a. Similarly, restricted presence information prepared for User 3 will be delivered to User 3's system to be displayed 1138b. It can be appreciated of course that it may be prudent to a to ascertain whether the user is still online, before actually attempting a communication. Alternatively, such a determination may not be necessary; if the user is no longer online, then the communication may simply fail to reach a destination.

The discussion will now turn to the notion of a “watcher list.” Quite simply, this is a list of users who need to know the presence of a particular user. Stated in another way, each user has an associated watcher list, which contains a list of users who need to know the presence of that user. The “need to know” arises when a user has requested information for a file. According to the invention that user will need to know the presence of each of the users associated with that file. For the same reason, each user group has an associated watcher list.

A watcher list can always be associated with a user (say, User A), and initially may be a null list (no entries). Suppose another user (say, User B) requests a directory listing which includes a file to which User A is associated (e.g., by owning it, or having modified it, etc). The CMS, in the processing portion shown in FIG. 9 as 932 (or in 936) will update the watcher list for User A by including User B into the list. Now, when the presence of User A changes, it can be determined that the change needs to be propagated to User B, assuming of course that User B is still online.

What is claimed is:

1. A computer implemented method for presenting information on a visual display device relating to shared files in a networked communication system comprising:
presenting some of the shared files;
presenting only those users who are associated with at least one of the files;
presenting presence information of a first user, including presenting contact information indicative of whether the first user is available for communication over the networked communication system;
if the first user is available for communication, presenting information indicative of one or more contact methods available for communication with the first user;
detecting an indication of a selected contact method for communicating with the first user; and
initiating a communication session with the first user based on the selected contact method.

2. The method of claim 1 further including detecting a user action and in response thereto presenting information indicative of one or more contact methods available for communication with the first user.

3. The method of claim 1 wherein the contact information is represented by a graphic element.

4. The method of claim 1 wherein the visual display device includes one of a video display monitor, a display incorporated in a laptop computer, a display incorporated in a personal data assistant, and a display incorporated in a telephone.

5. The method of claim 1 wherein the contact method includes one or more of voice over IP, instant messaging, and email.

6. The method of claim 1 wherein the step of presenting presence information includes presenting a graphic element on a display device, wherein the step of presenting contact information is performed in response to detecting an indication of a user-generated action on the graphic element.

7. The method of claim 1 wherein the users associated with the files are members of a peer-to-peer (P2P) communication network.

8. The method of claim 1 wherein the step of presenting some of the shared files includes one or more of presenting representations of individual files and presenting a representation of a directory.

9. A computer implemented method for presenting information on a visual display device relating to user groups in a networked communication system comprising:
presenting one or more user groups, each user group comprising one or more users;
for each user group, presenting group presence information associated with the user group, the group presence information being determined based on user presence information associated with one or more of the users in the user group;
detecting a first action and in response thereto presenting user information representative of first users in a first user group, the user information including identification information representative of the first users;
presenting presence information associated with a selected user from among the first users, the presence information indicative of whether the selected user is available for communication; and
initiating a communication session with an available user from among the first users, the presence information associated with the available user including information indicative of one or more contact methods, the communication session being initiated using one of the one or more contact methods.

10. The method of claim 9 further comprising detecting a second action, wherein the step of presenting presence information is performed in response to detecting the second action.

11. The method of claim 9 further comprising detecting a second action, wherein the step of initiating a communication session is performed in response to detecting the second action.

12. The method of claim 9 further including detecting a second action and in response thereto establishing a communication session with one or more users in a selected user group, wherein the second action is indicative of the selected user group.

13. The method of claim 12 further including determining, based on a privacy policy of the user, whether communication with a user in the selected user group can be established.

14. A computer implemented method for displaying information relating to files in a peer-to-peer network comprising:
obtaining file information representative of a plurality of files;
obtaining user information indicative of one or more users who are associated with the files, the obtaining being limited only to users who are associated with one or more of the files;
obtaining presence information for the one or more users, each user having associated presence information;
presenting, in a first area of a video display, information for one or more of the files and information identifying one or more associated users who are associated with the one or more files; and
presenting, in a second area of the video display, presence information of each of the associated users,
wherein the presence information for each associated user includes information indicating whether the associated user is available for communication and information indicating one or more contact methods for initiating communication with the associated user.

15. The method of claim 14 further including detecting a user action and in response thereto performing the step of presenting, in a second area of the video display, presence information of each of the associated users.

16. A computer operated method for displaying user groups for users in a peer-to-peer network comprising:
obtaining group information representative of one or more groups of peer users, the group information including, for each group, information identifying peer users in the group;
presenting, on a video display, information for at least one group, the information including group presence information associated with the group, the group presence information being determined based on presence information of one or more of the peer users in the group; and
detecting a first action and in response thereto:
updating the video display to show constituent peers users of a selected group;
obtaining presence information for the constituent peer users; and
presenting the presence information.

17. In a file sharing environment, a method for representing files in a first computer system comprising:
receiving a user request to display contents of a file folder; and
in response to receiving the user request:
communicating with a second computer system to receive first information representative of one or more files and second information representative of at least one group of files;
presenting the first information and the second information; and
presenting third information representative of presence information corresponding to the group of files, wherein the presence information is based on presence information of one or more constituent members of the group of files, the constituent members including files and sub-groups of files.

18. The method of claim 17 further comprising receiving the third information from the second computer system, wherein the third information is generated in the second computer system.

19. The method of claim 17 wherein the group of files comprises one or more files, the method further comprising receiving from the second computer system presence information for the one or files and generating in the first computer system the third information.

20. The method of claim 17 wherein the file sharing environment is a peer-to-peer network, the method further comprising receiving the third information from the second computer system, wherein the third information is generated in the second computer system.

21. The method of claim 17 wherein the file sharing environment is a peer-to-peer network and wherein the group of files comprises one or more files, the method further comprising receiving from the second computer system presence information for the one or files and generating in the first computer system the third information.

22. A computer program product comprising a computer readable medium containing computer program code, the computer program code effective for operating a computer to perform the method steps of claim 17.

23. In a peer-to-peer network, a method for representing peer users comprising:
receiving first information representative of one or more peer users who are on the system;
receiving second information representative of presence information associated with the one or more peer users;
receiving third information representative of one or more user groups;
presenting a hierarchical representation of the one or more peer users and the one or more user groups;
presenting user presence information associated with a first peer user, the user presence information representative of one or more user contact methods;
presenting group presence information associated with a first user group, the group presence information representative of one or more group contact methods; and
detecting a first user action and in response thereto establishing communication with the first peer user, wherein the first user action is indicative of a selected user contact method and wherein communication is established via the selected user contact method.

24. The method of claim 23 further including detecting a user selection action and in response thereto either performing the step of presenting presence information associated with the first peer user or performing the step of presenting presence information associated with the first user group.

25. The method of claim 23 further comprising detecting a second user action, wherein the second user action is indicative of a selected group contact method, the method further comprising, in response to detection of the second user action, establishing communication with one or more users who comprise the selected user group via the selected group contact method.

26. The method of claim 23 wherein the user presence information is presented as a graphic icon, wherein additional information representative of the user contact methods is presented in response to detecting a user action.

27. The method of claim 23 wherein the group presence information is presented as a graphic icon, wherein additional information representative of the group contact methods is presented in response to detecting a user action.

28. A computer program product comprising a computer readable medium containing computer program code, the computer program code effective for operating a computer to perform the method steps of claim 23.

29. A method for presenting information to peer users in a peer-to-peer (P2P) network comprising:
in a first computer system, receiving presence information from one or more peer users;
in the first computer system, receiving a privacy policy associated with each of the one or more peer users;
in a second computer system, presenting to a first peer user, file information representative of a collection of one or more files; and
for one or more of the files in the collection:
presenting to the first peer user, information identifying one or more peer users who are associated with the file; and
presenting to the first peer user, presence information for each peer user who is associated with the file, wherein the presence information is based on a presence of the peer user and based on the privacy policy associated with the peer user,
wherein the first peer user is presented with information only for those users who are associated with the file.

30. The method of claim 29 wherein the presence information is generated in the first computer system.

31. The method of claim 29 wherein the presence information is generated in the second computer system.

32. The method of claim 31 further comprising receiving from the first computer system privacy policy information so that the second computer system can generate the presence information.

33. The method of claim 29 wherein the collection of one or more files is a directory and the file information is an iconic representation of a directory.

34. The method of claim 29 wherein the file information comprises one or more iconic representations of each file in the collection of one or more files.

35. The method of claim 29 wherein the one or more peer users who are associated with the file include peer users who own the file, or who have modified the file.

36. The method of claim 29 wherein the presence of the peer user comprises information indicative of whether the peer user is online, is active, or has been idle.

37. The method of claim 29 wherein the steps of presenting includes displaying visual information on a visual display device.

38. The method of claim 37 wherein the visual display device includes one of a video display monitor, a display incorporated in a laptop computer, a display incorporated in a personal data assistant, and a display incorporated in a telephone.

39. A method for showing users in a networked communication system comprising:
storing presence information for users;
receiving a request for file information from a first user;
communicating to the first user first information comprising directory information which identifies one or more files, user information which identifies associated users who are associated with at least one of the files, and presence information for each associated user;
for each associated user, adding information that identifies the first user into a watcher list belonging to the associated user; and
receiving an indication that presence of a second user has changed and in response thereto communicating to the first user second information indicative of the second user's change of presence, if the first user is in the watcher list belonging to the second user.

40. The method of claim 39 wherein the first information further includes group information which identifies one or more user groups and group presence information for each user group, the group presence information for a user group being based on the presence information of at least some of the users comprising the group, and wherein communicating the second information to the first user is performed if the second user is in one of the one or more user groups and the group presence information for that user group has changed.
